(19) United States
(12) Patent Application Publication
(10) Pub. No.: US 2026/0250475 A1
(43) Pub. Date: Aug. 27, 2026

(54) BIO-BASED POLYURETHANE FOAM FORMULATION AND METHOD THEREOF

(71) Applicant: Nano and Advanced Materials Institute Limited, Hong Kong (HK)

(72) Inventors: Sik Chun Johnny LO, Hong Kong (HK); Mimi HETTI, Hong Kong (HK); JianPing HAN, Hong Kong (HK); Yong ZHU, Hong Kong (HK); Sui Han SIN, Hong Kong (HK)

(21) Appl. No.: 19/553,027

(22) Filed: Feb. 27, 2026

Related U.S. Application Data
(60) Provisional application No. 63/764,079, filed on Feb. 27, 2025.

(51) Int. Cl. C08J 9/14; B29C 44/02; B29K 75/00; B29K 105/00; C08G 18/10; C08J 9/08

(52) U.S. Cl. CPC C08J 9/142; B29C 44/02; C08G 18/10; C08J 9/08; B29K 2075/00; B29K 2105/0002; B29K 2995/0017; C08G 2110/0083; C08J 2201/022; C08J 2203/10; C08J 2203/12; C08J 2375/04

(57) ABSTRACT

A bio-based polyurethane foam formulation, comprising a polyol component having 50-90% by weight of one or more bio-based polyols derived from renewable resources, an isocyanate component comprising 40-70% by weight of one or more isocyanates, one or more additives, optionally present, selected from nucleating agents, surfactants, pore-opening stabilizers, chain extenders, crosslinking agents, and bio-fillers, a catalyst system having a gelling catalyst and/or a blowing catalyst, a blowing agent system comprising a chemical blowing agent and/or a physical blowing agent. All weight percentages are based on the total formulation. The bio-based polyurethane foam has a predetermined thermal decomposition temperature, a predetermined tensile strength, and a predetermined elongation at break.

### FIELD OF THE INVENTION

Embodiments of the present invention relate to field of materials science and polymer-based formulations, and specifically relates to a bio-based polyurethane foam formulation and method thereof to achieve high thermal resistance.

### DESCRIPTION OF THE RELATED ART

The present disclosure is describing a bio-based polyurethane foam formulation and an associated method of preparation that is focusing on achieving high renewable content while maintaining robust mechanical and structural performance e.g. high thermal resistance. The invention is integrating bio-based polyols derived from renewable resources with an isocyanate component and a controlled combination of additives, catalysts, blowing agents, chain extenders, crosslinking agents, and bio-based fillers. The formulation is incorporating one or more bio-fillers and includes nanosized nucleating agents to improve pore size control and morphological stability of the foam, while simultaneously employing environmentally friendly blowing agents such as water and acetone. The preparation method is utilizing controlled high-shear mixing and defined thermal conditions for forming a uniform open-cell foam structure. The resulting polyurethane foam is exhibiting fine cell morphology, enhanced compressive and tensile performance, improved elongation, and high bio-based carbon content along with high thermal resistance, enabling the foam to retain structural integrity and mechanical performance after exposure to elevated temperatures and heat-based post-processing treatments, including hot pressing, and demonstrating a decomposition temperature of at least 260° C. The disclosure is addressing thermal limitations of bio-based foams while preserving compatibility with conventional polyurethane processing equipment and industrial manufacturing practices. The foam material is supporting applications requiring lightweight structure, resilience, durability, and reduced environmental impact.

Existing bio-based polyurethane foam technologies are relying heavily on partial substitution of petrochemical polyols with renewable polyols, resulting in formulations that are exhibiting limited overall bio-based content. These systems are maintaining dependency on fossil-based components to sustain mechanical integrity and thermal stability. The foam structures are displaying compromised compressive strength, reduced tensile performance, and inconsistent cell morphology. The reliance on conventional formulations is restricting sustainability advancement while continuing environmental burden. These materials are remaining unsuitable for demanding applications requiring both performance and renewable content. The lack of holistic formulation design and low thermal resistance is limiting broader industrial adoption, as the foam is unable to retain structural and mechanical integrity during heat-based shaping processes, including hot-press forming.

Another disadvantage of existing inventions is arising from inadequate control of foaming reactions and cell nucleation behavior. Many conventional systems are employing only chemical blowing agents, resulting in uncontrolled gas evolution and irregular pore formation. The resulting foams are exhibiting large, non-uniform cell sizes and reduced open-cell content. Mechanical properties are deteriorating due to structural weaknesses within the foam matrix, particularly as a result of low thermal resistance, which causes degradation of the foam structure and reduction in mechanical performance after heating or hot-press processing. Processing reproducibility is suffering under scaled manufacturing conditions. The absence of synergistic nucleation strategies is preventing consistent foam quality.

A further disadvantage of current polyurethane foam technologies is originating from the continued use of toxic and environmentally harmful catalysts. Tin-based catalysts are remaining prevalent in many existing formulations. These catalysts are introducing health hazards, environmental contamination, and regulatory challenges. Manufacturing environments are facing increased safety requirements and disposal complexities. Sustainable compliance is becoming increasingly difficult under evolving regulations. The continued dependence on such catalysts is limiting the long-term viability of existing polyurethane foam solutions.

CN107151302B is describing a preparation method for vegetable oil based soft polyurethane foam derived from tung oil polyols and related renewable feedstocks. the disclosure is focusing on producing biodegradable and environmentally friendly foam materials through plant oil modification routes, however, the resulting polyurethane foams are exhibiting significantly reduced tensile strength, elongation, and compressive performance when compared to petroleum based polyurethane foams, the formulation strategy is primarily relying on renewable polyol substitution without addressing the structural reinforcement of the foam matrix, the foam morphology is showing limited control over pore size uniformity and open cell consistency, the mechanical deficiencies are restricting the use of such foams in applications requiring durability, resilience, and load bearing capacity.

CN117487114A is describing a zein modified bio based polyurethane flexible foam material that is addressing foaming stability and cell uniformity through protein-based modification, the disclosure is focusing on improving foam structure and resilience by introducing zein as a modifying agent, however, the prior art is not quantifying or ensuring the overall bio-based carbon content of the final foam material, the absence of defined renewable content metrics is limiting sustainability assessment and regulatory alignment. the approach is not establishing a balance between high renewable content and mechanical reinforcement. industrial scalability and reproducibility of properties remain insufficiently addressed.

CN116425947A is describing a high resilience bio based polyurethane soft foam and a corresponding preparation method aimed at improving rebound performance. the disclosure is achieving enhanced resilience comparable to petroleum-based foams, however, the formulation is limiting bio-based polyol usage to approximately fifty percent by weight. as a result, the overall bio-based carbon content remains below sustainability thresholds exceeding eighty percent, the solution is prioritizing resilience over renewable content optimization. this limitation is restricting applicability in markets demanding both high performance and high renewable material content.

U.S. Pat. No. 9,212,250B2 is describing polyurethane foam systems incorporating bio-based polyols while focusing on maintaining acceptable mechanical performance. the disclosure is addressing formulation balance issues associated with renewable polyols, however, the approach is not demonstrating fine open cell morphology control at high renewable content levels, the prior art is not integrating nanoscale bio fillers or synergistic processing strategies, the solution is remaining incremental rather than transformative in addressing combined sustainability and performance challenges.

U.S. Pat. No. 12,258,435B1 is describing tin free catalyst systems for polyurethane foam production and is focusing on environmental and health improvements by replacing tin-based catalysts. while the disclosure is improving catalyst sustainability, it is not addressing the broader formulation challenges associated with achieving very high renewable content and fine foam morphology, the prior art is not resolving mechanical degradation associated with high bio-based formulations. The prior art further addresses thermal resistance using polyisocyanurates (PIR) formation, but it does so by increasing isocyanate content, resulting in rigid, brittle foams with lower bio-based content and inferior mechanical balance. The present invention in contrast achieves high thermal resistance while maintaining high bio-based content, high elongation, and superior morphology stability.

The present disclosure is providing a general solution that is addressing the persistent limitations identified in existing prior arts relating to sustainability, mechanical performance, and foam morphology. The solution is integrating material selection, filler incorporation, blowing agent strategy, and processing control into a unified formulation and preparation approach. This integrated approach is addressing the disconnect between renewable content, mechanical integrity, and thermal stability that is present in prior disclosures. The solution is emphasizing structural uniformity, controlled cell formation, and reinforcement of the polymer network while maintaining a high proportion of renewable carbon content. The general solution is overcoming deficiencies related to weak mechanical properties, inconsistent pore structures, and limited sustainability metrics that are characteristic of existing technologies.

The present disclosure is further providing a solution that is aligning environmental responsibility with industrial practicality by enabling improved thermal stability. The solution is reducing reliance on hazardous components while improving reproducibility and scalability of foam production. The approach is supporting compatibility with existing manufacturing equipment and processes, thereby facilitating adoption without extensive infrastructure changes. The solution is enabling production of polyurethane foams that are achieving balanced performance across mechanical strength, resilience, morphology, and sustainability. This general solution framework is addressing the shortcomings of prior arts by advancing a holistic and integrated strategy rather than isolated material substitutions or incremental process changes.

### SUMMARY OF THE INVENTION

Embodiments of the present invention relate to a bio-based polyurethane foam formulation. The formulation comprising a polyol component comprising 50-90% by weight of one or more bio-based polyols derived from renewable resources. The formulation further comprises an isocyanate component comprising 40-70% by weight of one or more isocyanates. The formulation also comprising one or more additives, optionally present, selected from nucleating agents, surfactants, pore-opening stabilizers, chain extenders, and bio-fillers. The formulation also comprising a catalyst system comprising a gelling catalyst and/or a blowing catalyst. The formulation also comprising a blowing agent system comprising a chemical blowing agent and/or a physical blowing agent, wherein all weight percentages are based on the total formulation. The bio-based polyurethane foam has a predetermined thermal decomposition temperature, a predetermined tensile strength, and a predetermined elongation at break.

In accordance with an embodiment of the present invention, the bio-based polyols are selected from polyester polyols for enhanced thermal resistance, polyether polyols, or combinations thereof.

In accordance with an embodiment of the present invention, the bio-based polyol has a functionality of 2 to 6.

In accordance with an embodiment of the present invention, the bio-based polyol has a hydroxyl number of 20-100 mg KOH/g.

In accordance with an embodiment of the present invention, the bio-based polyol has a molecular weight of 400 to 12,000 Da and a viscosity of 20 to 2,000 cps.

In accordance with an embodiment of the present invention, the isocyanate component has an NCO content of 15-60% and a viscosity of 20 to 2,000 cps.

In accordance with an embodiment of the present invention, the one or more additives comprise nanosized nucleating agents as a bio-filler, that improves pore nucleation, structural integrity, and thermal resistance of the resulting polyurethane foam. In alternative embodiments, other bio-based or nano-cellulosic fillers may be used in place of or in combination with cellulose nanocrystals and inorganic nanoparticles selected from nano-silica and nano-clay. In accordance with an embodiment of the present invention, the one or more additives comprise one or more nucleating agents present in an amount of up to 2 wt %.

In accordance with an embodiment of the present invention, the nanosized nucleating agents are present in an amount of up to 3 wt % and have an average particle size of 5-50 nm.

In accordance with an embodiment of the present invention, the catalyst system comprises a gelling catalyst in an amount of up to 2 wt % and/or a blowing catalyst in an amount of up to 0.4 wt %.

In accordance with an embodiment of the present invention, the chemical blowing agent comprises water in an amount of up to 5 wt %.

In accordance with an embodiment of the present invention, the physical blowing agent comprises acetone in an amount of up to 20 wt %. Acetone is described herein as one illustrative example of a physical blowing agent and is not intended to be limiting.

In accordance with an embodiment of the present invention, the one or more additives comprise one or more surfactants present in an amount of up to 2 wt %.

In accordance with an embodiment of the present invention, the one or more additives comprise one or more pore-opening stabilizers present in an amount of up to 5 wt %.

In accordance with an embodiment of the present invention, the one or more additives comprise one or more chain extenders present in an amount of up to 10 wt %.

In accordance with an embodiment of the present invention, the one or more additives comprise one or more cross-linking agents present in an amount of up to 10 wt %.

In accordance with an embodiment of the present invention, the bio-based polyurethane foam exhibits a compressive strength of at least 25 kPa, a density of less than 150 kg/m³, and an open-pore structure of at least 80%.

In accordance with an embodiment of the present invention, the bio-based polyurethane foam has a predetermined thermal decomposition temperature of at least 260° C., a predetermined tensile strength of at least 1,000 kPa, and a predetermined elongation at break of at least 450%.

In accordance with an embodiment of the present invention, the foam has a bio-based content greater than 80%.

Another embodiment of the present invention relates to a method for producing a bio-based polyurethane foam. The method comprises the steps of forming a polyol-based mixture by combining 50-90% by weight of one or more bio-based polyols derived from renewable resources, optionally one or more additives, a catalyst system comprising a gelling catalyst and/or a blowing catalyst, and, optionally a chemical blowing agent, wherein all weight percentages are based on the total formulation.

In accordance with an embodiment of the present invention, the method further comprising the steps of forming an isocyanate-based mixture (Part B) by combining 40-70% by weight of one or more isocyanates, and optionally a physical blowing agent; combining the polyol-based mixture (Part A) and the isocyanate-based mixture (Part B) to initiate a foaming reaction; and allowing the reaction mixture to foam and cure in a mold to form the bio-based polyurethane foam.

In accordance with an embodiment of the present invention, the method further comprising the steps of adding a flexible foam polyol in the bio-based polyol to form Part A2; dehydrating polyol-based chemicals in Part A2; combining the polyols in Part A2 with an isocyanate (Part A1) to initiate a reaction forming a prepolymer solution (Part A); forming a secondary polyol-based mixture (Part B); combining Part A and Part B to initiate a foaming reaction; and allowing the reaction mixture to foam and cure in a mold to form the bio-based polyurethane foam.

In accordance with an embodiment of the present invention, the bio-based polyols are selected from polyester polyols, polyether polyols, or combinations thereof.

In accordance with an embodiment of the present invention, forming the polyol-based mixture comprises mixing in a mixing head or high-shear mixing head at a speed of 1,000-10,000 rpm for 1-10 minutes.

In accordance with an embodiment of the present invention, the mold temperature is maintained at 40-90° C. for 5-60 minutes.

In accordance with an embodiment of the present invention, further comprising demolding the foam and subjecting the foam to post-curing.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1 illustrates a flowchart for a method for producing a bio-based polyurethane foam, in accordance with an embodiment of the present invention;

FIG. 2A illustrates a polyurethane gelling reaction between polyols and isocyanates, in accordance with an embodiment of the present invention;

FIG. 2B illustrates a blowing reaction involving isocyanates and water leading to gas generation, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “a” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiment include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present invention. The terms “determining”, “measuring”, “evaluating”, “assessing,” “assaying,” and “analyzing” can be used interchangeably herein to refer to any form of measurement and include determining if an element is present or not. (e.g., detection). These terms can include both quantitative and/or qualitative determinations. Assessing may be relative or absolute.

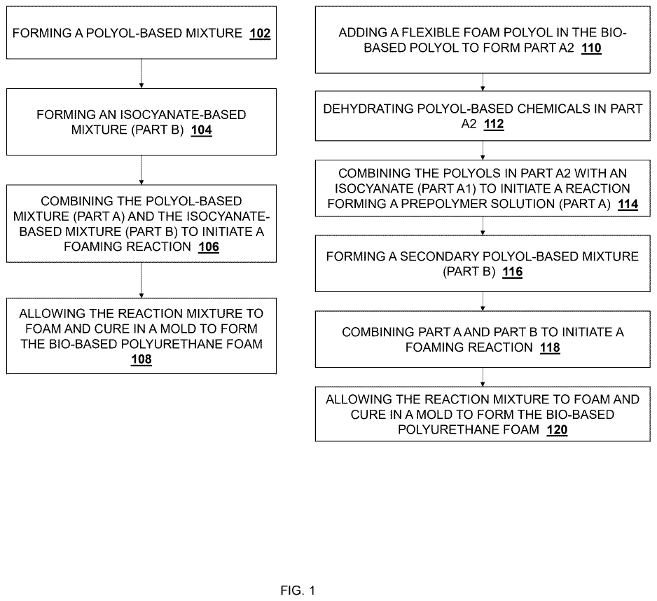

FIG. 1 illustrates a flowchart for a method 100 for producing a bio-based polyurethane foam, in accordance with an embodiment of the present invention.

At the step 102, the polyol-based mixture is being formed by combining one or more bio-based polyols derived from renewable resources with selected auxiliary constituents in accordance with the formulation and process disclosed in the specification, thereby establishing an initial and foundational stage of the method 100 for producing the bio-based polyurethane foam in which chemical composition, dispersion quality, and reactivity are being defined prior to initiation of foaming reactions.

The one or more bio-based polyols are being introduced into a vessel in an amount ranging from 50 wt % to 90 wt %, based on the total formulation. The bio-based polyols are being selected from polyester polyols, polyether polyols, or combinations thereof, and are being derived from renewable resources including plant oils such as castor oil, soybean oil, rapeseed oil, sunflower oil, and other organic feedstocks. The bio-based polyols are being characterized by a functionality ranging from 2 to 6, a hydroxyl number ranging from 20 mg potassium hydroxide per gram to 100 mg potassium hydroxide per gram, a molecular weight ranging from 400 daltons to 12,000 daltons, and a viscosity ranging from 20 centipoise to 2,000 centipoise, thereby providing controlled reactivity, processability, and compatibility with subsequent reactions involving the isocyanate.

Optional additives are being introduced into the polyol-based mixture to tailor foam morphology, mechanical performance, and processing behavior. The one or more additives are being selected from nucleating agents, surfactants, pore-opening stabilizers, chain extenders, crosslinking agents, and bio-fillers, and are being incorporated individually or in combination depending on desired foam characteristics. The additives are being present in predefined amounts, wherein nucleating agents are being added in an amount of up to 2 wt % to promote uniform cell nucleation, surfactants are being added in an amount of up to 2 wt % to stabilize foam cells and control cell size, pore-opening stabilizers are being added in an amount of up to 5 wt % to ensure development of an open-pore structure, and chain extenders are being added in an amount of up to 10 wt % to enhance molecular weight growth and mechanical strength of the polymer network, and further crosslinking agents are added in an amount of up to 10 wt % to increase crosslink density, thereby improving structural integrity and thermal stability of the resulting polyurethane foam.

Bio-fillers are being optionally incorporated into the polyol-based mixture to increase overall bio-based content and to influence nucleation and reinforcement of the foam structure, while further enhancing the thermal stability and heat resistance of the resulting polyurethane foam. In one embodiment, the bio-filler comprises cellulose nanocrystals and inorganic nanoparticles selected from nano-silica and nano-clay, added in an amount of up to 3 wt % and characterized by an average particle size ranging from 5 nm to 50 nm. The cellulose nanocrystals and inorganic nanoparticles selected from nano-silica and nano-clay are being distributed within the polyol matrix to may act as nucleation sites during foaming and to provide mechanical reinforcement at the nanoscale, thereby may contributing to enhanced compressive strength, tensile strength, and elongation performance of the final foam.

A catalyst system is being incorporated into the polyol-based mixture to regulate reaction kinetics during subsequent gelling and blowing reactions. The catalyst system comprises a gelling catalyst and or a blowing catalyst, wherein the gelling catalyst is being selected to accelerate reactions between hydroxyl groups of the bio-based polyols and isocyanate groups of the isocyanate component, and the blowing catalyst is being selected to promote efficient gas generation from chemical blowing agents. The catalyst system is being introduced in controlled predefined amounts, with gelling catalysts being present in an amount of up to 2 wt % and blowing catalysts being present in an amount of up to 0.4 wt %, and, in certain embodiments, the catalyst system may be substantially free from tin-based catalysts to improve environmental compatibility.

Optional chemical blowing agents are being incorporated into the polyol-based mixture as part of the blowing agent system. The chemical blowing agent comprises water added in an amount of up to 5 wt %, wherein the water is configured to react with isocyanate groups during later stages of the process to generate carbon dioxide gas. The inclusion of the chemical blowing agent is being performed in a controlled manner to ensure uniform distribution within the polyol-based mixture while avoiding premature gas generation prior to combination with an isocyanate-based mixture.

Mixing of the bio-based polyols, optional additives, bio-fillers, catalyst system, and optional chemical blowing agent is being performed to achieve a preliminary dispersion sufficient to define the polyol-based mixture. The formation of the polyol-based mixture is being carried out under conditions that prevent phase separation, sedimentation of bio-fillers, or localized concentration gradients of additives or catalysts. The resulting polyol-based mixture is being characterized by uniform composition, stable rheological behavior, and readiness for subsequent high-shear homogenization, vacuum degassing, reactive combination with the isocyanate-based mixture, and controlled foaming and curing within a mold, thereby enabling formation of a bio-based polyurethane foam which, in certain embodiments, may have a bio-based content greater than 80%, an open-pore structure, and enhanced mechanical and thermal performance as disclosed in the specification.

The method 100 may include adding a polyol, a plurality of additives, and a bio-filler in predefined amounts within a vessel to obtain a primary mixture.

The method 100 may include mixing the primary mixture in controlled high-shear mixing conditions sufficient to achieve a homogeneous dispersion of the polyol, the plurality of additives, and the bio-filler.

The method 100 may include adding catalysts and one or more chemical bowling agents in predefined amounts to the homogeneous primary mixture to form a first mixture.

The homogeneous primary mixture may optionally be subjected to vacuum treatment prior to formation of the first mixture to remove entrapped air and dissolved gases. At the step 102, high-shear mixing of the polyol-based mixture is being carried out to achieve a homogeneous dispersion of the bio-based polyols, the plurality of additives, the bio-filler, the catalyst system, and any optional chemical blowing agent, thereby establishing uniform physicochemical conditions required for controlled foaming and curing in subsequent stages of the method 100. This step is being performed as a critical homogenization stage in which dispersion quality, interfacial compatibility, and reaction uniformity are being actively controlled prior to introduction of the isocyanate-based mixture.

The polyol-based mixture formed in the preceding step is being subjected to controlled high-shear mixing conditions within a mixing head or high-shear mixing head. The high-shear mixing is being conducted at a rotational speed ranging from 1,000 revolutions per minute to 10,000 revolutions per minute for a duration ranging from 1 minute to 10 minutes, wherein shear energy input is being selected to overcome agglomeration forces and viscosity gradients within the mixture. The applied shear forces are being sufficient to disperse cellulose nanocrystals where present, having an average particle size ranging from 5 nm to 50 nm, and inorganic nanoparticles selected from nano-silica and nano-clay, uniformly throughout the polyol matrix, thereby preventing localized clustering and ensuring nanoscale distribution of the bio-filler.

During this step, the bio-based polyols having a functionality ranging from 2 to 6, a hydroxyl number ranging from 20 mg potassium hydroxide per gram to 100 mg potassium hydroxide per gram, and a viscosity ranging from 20 centipoise to 2,000 centipoise are being subjected to intensive mechanical mixing that promotes intimate contact with nucleating agents, surfactants, pore-opening stabilizers, and chain extenders. The high-shear environment is being effective in distributing surfactants present in an amount of up to 2 wt % along developing interfaces, thereby stabilizing the mixture and preparing the system for subsequent cell formation. Nucleating agents present in an amount of up to 2 wt % are being uniformly dispersed to ensure consistent nucleation density during foaming.

The pore-opening stabilizers present in an amount of up to 5 wt % are being homogeneously incorporated to regulate cell opening behavior during foam expansion, while chain extenders present in an amount of up to 10 wt % are being evenly distributed to support uniform polymer chain growth during gelling reactions. The catalyst system comprising gelling catalysts present in an amount of up to 2 wt % and blowing catalysts present in an amount of up to 0.4 wt % is being uniformly dispersed to ensure consistent reaction kinetics throughout the entire volume of the polyol-based mixture.

As part of step 102, vacuum treatment is being optionally applied to the polyol-based mixture following or during high-shear mixing. The vacuum treatment is being conducted to remove entrapped air, dissolved gases, and microbubbles introduced during mixing. The removal of entrained gases is being performed to prevent uncontrolled bubble growth, foam collapse, or defect formation during later foaming stages. The vacuum treatment is being maintained until the polyol-based mixture exhibits a visibly degassed and stable state, thereby improving reproducibility and structural uniformity of the final bio-based polyurethane foam.

In one embodiment, the bio-based polyurethane foam has a predetermined thermal decomposition temperature, a predetermined tensile strength, and a predetermined elongation at break.

In one embodiment, the bio-based polyurethane foam has a predetermined thermal decomposition temperature of at least 260° C., a predetermined tensile strength of at least 1,000 kPa, and a predetermined elongation at break of at least 450%.

The high shear mixing conditions are being selected to maintain thermal stability of the mixture while avoiding premature initiation of gelling or blowing reactions. Temperature rise associated with shear input is being inherently controlled by selection of mixing speed, duration, and vessel geometry, thereby preserving chemical stability of the polyol-based mixture prior to combination with the isocyanate-based mixture. The mixture emerging from this step is being characterized by uniform viscosity, absence of phase separation, and consistent dispersion of all solid and liquid constituents.

Completion of step 102 results in a homogeneous polyol-based mixture that is being chemically active yet physically stable, enabling precise control over subsequent reactive processing. The uniform dispersion achieved during this step is being directly correlated with uniform cell size distribution, controlled open-pore structure, and enhanced mechanical properties of the final foam, including compressive strength, tensile strength, elongation at break, and thermal stability. The polyol-based mixture produced at this stage is being fully prepared for controlled addition of chemical blowing agents where applicable, followed by reactive combination with the isocyanate-based mixture to initiate gelling and blowing reactions in a predictable and reproducible manner.

At the step 102, catalysts and one or more chemical blowing agents are being added to the homogeneous polyol-based mixture obtained from the preceding high-shear mixing step, thereby forming a first mixture that is chemically activated for subsequent gelling and blowing reactions. This step is being carried out to precisely regulate reaction kinetics, gas generation behavior, and foam morphology prior to reactive contact with the isocyanate-based mixture, while maintaining uniform distribution of all reactive constituents throughout the formulation.

During this step, the catalyst system is being introduced into the homogeneous polyol-based mixture in predefined amounts selected to balance gelling and blowing reactions. The catalyst system comprises one or more gelling catalysts and or one or more blowing catalysts, wherein the gelling catalysts are being incorporated in an amount of up to 2 wt % and the blowing catalysts are being incorporated in an amount of up to 0.4 wt %, based on the total formulation. The gelling catalysts are being selected to accelerate the reaction between hydroxyl groups of the bio-based polyols and isocyanate groups of the isocyanate component introduced in a later step, thereby controlling polymer network formation and mechanical strength development. The blowing catalysts are being selected to enhance the rate and uniformity of gas generation from chemical blowing agents, thereby supporting controlled foam expansion.

The catalyst system added at this step is being substantially free from tin-based catalysts, including dibutyltin dilaurate, and is instead being selected from environmentally friendly alternatives such as bismuth-based catalysts and amine-based catalysts. The incorporation of a tin-free catalyst system at this stage is being performed to reduce toxicity, improve environmental sustainability, and maintain compliance with regulatory and occupational safety requirements, while still providing effective catalytic activity for polyurethane formation and foaming reactions.

Concurrently with catalyst addition, one or more chemical blowing agents are being added to the homogeneous polyol-based mixture to form the first mixture. The chemical blowing agent comprises water, which is being incorporated in an amount of up to 5 wt %. The water is being uniformly dispersed throughout the polyol-based mixture under controlled mixing conditions to prevent localized concentration gradients. The water introduced at this step is being configured to react with isocyanate groups during subsequent combination with the isocyanate-based mixture, thereby generating carbon dioxide gas in situ to drive foam expansion.

The addition of the chemical blowing agent at this step is being carefully controlled to ensure that no premature gas evolution occurs prior to reactive mixing with the isocyanate component. The homogeneous dispersion achieved in the previous high-shear mixing step is being maintained, and the mixture is being handled under conditions that preserve chemical stability until foaming reactions are intentionally initiated. The presence of nucleating agents and nanoparticles, including cellulose nanocrystals and inorganic nanoparticles selected from nano-silica and nano-clay, already dispersed in the mixture is being leveraged at this stage to provide controlled nucleation sites for gas bubble formation once carbon dioxide generation begins.

Mixing during step 102 is being conducted under conditions sufficient to distribute the catalyst system and chemical blowing agent uniformly without introducing excessive shear that could destabilize the mixture or trigger premature reactions. The first mixture formed at this stage is being characterized by a uniform catalytic activity profile and a consistent chemical blowing agent concentration across the entire volume, thereby enabling predictable foaming behavior during subsequent processing.

The formation of the first mixture at step 102 establishes the chemical readiness of the polyol-based system for reactive combination with the isocyanate-based mixture. The precise balance of gelling catalysts, blowing catalysts, and chemical blowing agents introduced at this step is being configured to ensure synchronized polymerization and gas generation, which is critical for achieving an open-pore foam structure, controlled cell size below 3 millimeters, improved thermal resistance, and enhanced mechanical properties including compressive strength, tensile strength, and elongation at break.

Upon completion of step 102, the first mixture remains stable, homogeneous, and chemically primed for foaming, enabling efficient and controlled initiation of gelling and blowing reactions when subsequently combined with the isocyanate-based mixture. The controlled activation achieved at this stage directly contributes to the formation of a bio-based polyurethane foam having a bio-based carbon content exceeding 80%, uniform cell morphology, and reproducible performance characteristics as disclosed in the specification.

In one embodiment of the present disclosure, the method 100 further comprising the steps of forming an isocyanate-based mixture (Part B) by combining (i) 40-70% by weight of one or more isocyanates, and (ii) optionally a physical blowing agent; combining the polyol-based mixture (Part A) and the isocyanate-based mixture (Part B) to initiate a foaming reaction; and allowing the reaction mixture to foam and cure in a mold to form the bio-based polyurethane foam.

At the step 104, forming an isocyanate-based mixture (Part B) by combining (i) 40-70% by weight of one or more isocyanates, and (ii) optionally a physical blowing agent.

The method 100 may include mixing an isocyanate and one or more physical blowing agents in predefined amounts within a separate vessel to obtain a second mixture.

At the step 104, the isocyanate-based mixture (Part B) is being formed by combining one or more isocyanates with one or more physical blowing agents in a separate vessel, thereby establishing a reactive counterpart to the polyol-based mixture (Part A) prepared in the preceding steps. This step is being carried out as a distinct and controlled operation to ensure that the isocyanate component remains chemically stable, uniformly blended, and optimally conditioned for subsequent reactive combination, while preventing premature reactions or volatilization of the physical blowing agents.

During this step, the one or more isocyanates are being introduced into a dedicated vessel in an amount ranging from 40 wt % to 70 wt %, based on the total formulation. The isocyanates are being selected from aromatic isocyanates, aliphatic isocyanates, or combinations thereof, including methylene diphenyl diisocyanate, toluene diisocyanate, hexamethylene diisocyanate, isophorone diisocyanate, benzene-1,4-diisocyanate, pentamethylene diisocyanate, or mixtures thereof. The isocyanate component is being characterized by an isocyanate content ranging from 15% to 60% and a viscosity ranging from 20 centipoise to 20,000 centipoise, thereby ensuring compatibility with the polyol-based mixture (Part A) and enabling controlled reaction kinetics during subsequent foaming.

The isocyanate component used at this step may be bio-based, petroleum-based, or a combination thereof, provided that the overall formulation achieves a bio-based carbon content exceeding 80% in the final bio-based polyurethane foam. When bio-based isocyanates are employed, the isocyanates are being derived from renewable or partially renewable feedstocks, thereby contributing to the sustainability objectives of the formulation while maintaining the reactivity and performance required for polyurethane foam production.

At the step 104, one or more physical blowing agents are being added to the isocyanate component in predefined amounts to form the isocyanate-based mixture. The physical blowing agents are incorporated in an amount of up to 20 wt %, and more specifically in an amount ranging from 3 wt % to 15 wt %, based on the total formulation. Non-limiting examples of the physical blowing agents include acetone, hydrocarbons, ketones, ethers, esters, or combinations thereof. In one embodiment, acetone is used as the physical blowing agent due to its volatility, environmental compatibility, and ability to vaporize under foaming conditions to generate gas for foam expansion without undergoing chemical reaction with the isocyanate component.

The addition of the physical blowing agent at this step is being conducted under controlled temperature and mixing conditions to ensure complete and uniform dispersion of acetone within the isocyanate phase. The isocyanate-based mixture is being maintained at conditions that suppress premature evaporation of the acetone, thereby preserving the blowing agent concentration until the point of reactive mixing with the polyol-based mixture (Part A). The separation of the physical blowing agent into the isocyanate-based mixture, rather than the polyol-based mixture (Part A), is being configured to enhance process stability and to enable precise control of gas generation during the foaming reaction.

Mixing during step 104 is being carried out using a mixer sufficient to achieve homogeneity without inducing excessive shear or heat buildup. The mixing conditions are being selected to ensure that the physical blowing agent is evenly distributed throughout the isocyanate component, while avoiding localized concentration gradients that could lead to non-uniform cell size or foam collapse during expansion. The resulting isocyanate-based mixture is being characterized by consistent viscosity, uniform blowing agent distribution, and stable storage behavior over the short duration prior to combination with the polyol-based mixture (Part A).

The chemical integrity of the isocyanate groups is being preserved throughout step 104, with no significant reaction occurring between the isocyanate component and the physical blowing agent. The isocyanate-based mixture thus remains chemically reactive yet physically stable, ready to undergo gelling reactions with hydroxyl groups of the bio-based polyols and blowing reactions driven by both chemical blowing agents and physical blowing agents upon subsequent combination.

At the step 104, the formation of the isocyanate-based mixture (Part B) is being deliberately isolated from the formation of the polyol-based mixture (Part A) to allow independent optimization of composition, mixing, and handling conditions. This separation ensures that sensitive components such as acetone are introduced at the most appropriate stage of the process, thereby minimizing losses due to volatilization and maximizing foaming efficiency during the reactive stage.

At the step 106, combining the polyol-based mixture (Part A) and the isocyanate-based mixture (Part B) to initiate a foaming reaction. The isocyanate-based mixture (Part B) prepared at step 104 is being configured to interact synergistically with the polyol-based mixture (Part A) formed at step 102. Upon subsequent combination, the isocyanate groups are being positioned to react with hydroxyl groups of the bio-based polyols to form urethane linkages, while the physical blowing agent is being positioned to vaporize in response to exothermic heat generated during polymerization.

Completion of step 106 results in a uniform, stable, and reactive polymer-forming mixture that supports synchronized gelling and blowing reactions during the foaming stage. The controlled preparation of the reactive polymer-forming mixture at this step directly contributes to the formation of a bio-based polyurethane foam exhibiting an open-pore structure, an average pore size of less than 3 millimeters, a density of less than 150 kilograms per cubic meter, and enhanced mechanical properties including compressive strength, tensile strength, and elongation at break.

The method 100 may include combining the first mixture and the second mixture in a mixing head to initiate gelling reactions and blowing reactions to form a reactive foam-forming mixture.

The controlled high-shear mixing is carried out at a rotational speed ranging from 1,000 revolutions per minute to 10,000 revolutions per minute wherein the controlled high-shear mixing is performed for a duration ranging from 1 minute to 10 minutes.

The first mixture and the second mixture are combined in the mixing head for a duration ranging from 10 seconds to 30 seconds.

The mold is maintained at a temperature ranging from 40 degrees celsius to 90 degrees celsius during foaming and curing.

The mold is selectively pressurized or unpressurized during foaming to control foam density and cell structure.

At the step 108, allowing the reaction mixture to foam and cure in a mold to form the bio-based polyurethane foam. The method 100 may include transferring the reactive foam-forming mixture into a mold and allowing the reactive foam-forming mixture to expand, foam, and cure to produce the bio-based polyurethane foam.

The reactive foam-forming mixture is allowed to foam and cure within the mold for a duration ranging from 5 minutes to 60 minutes.

The method 100 further comprising a post-curing step in which the demolded bio-based polyurethane foam is maintained at a temperature ranging from 10 degrees celsius to 40 degrees celsius, wherein the post-curing step is carried out for a duration ranging from 12 hours to 60 hours.

In one embodiment of the present disclosure, the bio-based polyurethane foam is exhibiting an open-cell structure with an average cell diameter of less than 3 millimeters, wherein the cell size distribution is being regulated by coordinated gelling reactions, blowing reactions, and nucleation effects of the bio-filler.

In one embodiment of the present disclosure, mechanical, thermal, and structural properties of the bio-based polyurethane foam are being evaluated, with particular emphasis on thermal resistance and the ability of the foam to maintain its mechanical and structural integrity following exposure to thermal stress and heat-based treatments, in accordance with applicable ASTM and ISO standard test methods to ensure reproducible and comparable performance characterization.

In one embodiment of the present disclosure, high-shear mixing is being carried out at a rotational speed equal to or greater than 4,000 revolutions per minute to achieve uniform dispersion of cellulose nanocrystals, additives, and catalysts within the polyol phase.

In one embodiment of the present disclosure, a foam production device is being configured to process up to a defined foam volume with a controlled foam rise height, wherein the device is maintaining uniform mixing, controlled expansion, and stable foam formation during production.

In another embodiment of the present disclosure, the method 100 further comprising the steps of adding a flexible foam polyol in the bio-based polyol to form Part A2; dehydrating polyol-based chemicals in Part A2; combining the polyols in Part A2 with an isocyanate (Part A1) to initiate a reaction forming a prepolymer solution (Part A); forming a secondary polyol-based mixture (Part B); combining Part A and Part B to initiate a foaming reaction; and allowing the reaction mixture to foam and cure in a mold to form the bio-based polyurethane foam.

At the step 110, adding a flexible foam polyol in the bio-based polyol to form Part A2. The incorporation of the flexible foam polyol is carried out under controlled mixing conditions to ensure homogeneity. The resulting Part A2 is configured to adjust flexibility, resilience, and overall foam performance characteristics.

At the step 112, dehydrating polyol-based chemicals in Part A2. The polyol-based chemicals in Part A2 are dehydrated to remove residual moisture present in the bio-based polyol and the flexible foam polyol. The dehydration step prevents premature reaction between water and isocyanate groups, thereby ensuring controlled prepolymer formation, uniform foaming, and improved mechanical and thermal stability of the resulting bio-based polyurethane foam.

At the step 114, combining the polyols in Part A2 with an isocyanate (Part A1) to initiate a reaction forming a prepolymer solution (Part A). The polyols in Part A2 are combined with the isocyanate (Part A1) under controlled mixing conditions to initiate a reaction between hydroxyl groups of the polyols and isocyanate groups, thereby forming an isocyanate-terminated prepolymer solution (Part A).

The isocyanate (Part A1) is being configured to interact synergistically with the dehydrated polyol-based chemicals in Part A2. This reaction between the polyols in Part A2 and the isocyanate (Part A1) results in the formation of the prepolymer solution (Part A). The formation of the prepolymer enables improved control over polymer network development, resulting in enhanced structural integrity and thermal stability of the resulting bio-based polyurethane foam.

At the step 116, a secondary polyol-based mixture (Part B) is prepared by combining one or more bio-based polyols with selected additives including catalysts, surfactants, chain extenders, crosslinking agents, and blowing agents.

At step 118, the prepolymer solution (Part A) is combined with the secondary polyol-based mixture (Part B) under controlled mixing conditions to initiate foaming and polymerization reactions. The interaction between isocyanate-terminated prepolymer solution (Part A) and reactive components in Part B results in gas generation, crosslinked network formation, and development of a uniform foam structure exhibiting enhanced mechanical integrity and thermal resistance.

At the step 120, the method 100 may include transferring the reactive foam-forming mixture into a mold and allowing the reactive foam-forming mixture to expand, foam, and cure to produce the bio-based polyurethane foam.

The reactive foam-forming mixture is allowed to foam and cure within the mold for a duration ranging from 5 minutes to 60 minutes.

The method 100 further comprising a post-curing step in which the demolded bio-based polyurethane foam is maintained at a temperature ranging from 10 degrees celsius to 40 degrees celsius, wherein the post-curing step is carried out for a duration ranging from 12 hours to 60 hours.

In one embodiment of the present disclosure, the bio-based polyurethane foam is exhibiting an open-cell structure with an average cell diameter of less than 3 millimeters, wherein the cell size distribution is being regulated by coordinated gelling reactions, blowing reactions, and nucleation effects of the bio-filler.

In one embodiment of the present disclosure, mechanical, thermal, and structural properties of the bio-based polyurethane foam are being evaluated, with particular emphasis on thermal resistance and the ability of the foam to maintain its mechanical and structural integrity following exposure to thermal stress and heat-based treatments, in accordance with applicable ASTM and ISO standard test methods to ensure reproducible and comparable performance characterization.

In one embodiment of the present disclosure, high-shear mixing is being carried out at a rotational speed equal to or greater than 4,000 revolutions per minute to achieve uniform dispersion of cellulose nanocrystals, inorganic nanoparticles including nano-silica and nano-clay, additives, and catalysts within the polyol phase.

In one embodiment of the present disclosure, a foam production device is being configured to process up to a defined foam volume with a controlled foam rise height, wherein the device is maintaining uniform mixing, controlled expansion, and stable foam formation during production.

In an exemplary embodiment, Table 1 presents the mechanical properties of bio-based polyurethane foams according to Embodiment 1 and Embodiment 2, evaluated before and after thermal treatment via hot-press processing, demonstrating improved retention of mechanical integrity and thermal resistance in Embodiment 2 compared to Embodiment 1.

TABLE 1

| | Embodiment 1 | | Embodiment 2 | |
|---|---|---|---|---|
| | Before | After | Before | After |
| | hotpress | hotpress | hotpress | hotpress |
| Hotpress method | — | 150° C. | — | 170° C. |
| | | 5-10 min | | 5-10 min |
| Density (kg/m3) | 80-100 | 205-242 | ~135 | ~325 |
| Hardness (shore | 70-80 | ~60 | ~55 | 72-78 |
| F) | | | | |
| Tensile Strength | 1275 ± 103 | 554 ± 17 | 2195 ± 188 | 3990 ± 196 |
| (Kpa) | | | | |
| Elongation (%) | 580 ± 21 | 99 ± 0.7 | 342 ± 8.5 | 454 ± 55 |
| Tear strength | 7517 ± 776 | 2104 | 4980 | 9500 |
| (N/m) | | | | |
| Resilience (%) | 28.2 ± 0.6 | 7.4 ± 0.2 | 14.7 ± 0.4 | 5.9 ± 0.6 |

In Embodiment 1, the high bio-based content foam formed by single-step direct pour method is subjected to hot pressing at approximately 150° C. for 5-10 minutes. Following the hot press process, the density increases from approximately 80-100 kg/m³ to 205-242 kg/m³, indicating structural densification. However, the mechanical properties deteriorate significantly. The tensile strength decreases from approximately 1275±103 kPa to 554±17 kPa, elongation decreases from approximately 580±21% to 99±0.7%, and tear strength decreases from approximately 7517±776 N/m to 2104 N/m. The resilience also decreases substantially. This demonstrates degradation of the foam structure due to thermal treatment.

In Embodiment 2, the high bio-based polyurethane foam of the present invention formed by pre-polymer based method is subjected to hot pressing at approximately 170° C. for 5-10 minutes. After thermal treatment, the density increases from approximately 135 kg/m³ to 325 kg/m³, indicating effective structural consolidation. The tensile strength increases significantly from approximately 2195±188 kPa to 3990±196 kPa, elongation increases from approximately 342±8.5% to 454±55%, and tear strength increases from approximately 4980 N/m to 9500 N/m. The hardness also increases from approximately 55 Shore F to 72-78 Shore F, indicating enhanced structural integrity. Importantly, the mechanical properties are maintained or improved.

These results demonstrate that, unlike conventional high bio-based content foams, the bio-based polyurethane foam of the present invention retains and improves mechanical performance after thermal processing. This indicates improved crosslink stability, structural integrity, and thermal durability, enabling the foam to be used in applications requiring thermal forming, hot pressing, or elevated temperature processing.

In an exemplary embodiment, Table 1A presents the formulation and component mass ratios used for producing the bio-based polyurethane foam according to the Embodiment 1, employing the single-step direct pour method.

TABLE 1A

| | | Mass ratio |
|---|---|---|
| Part A (polyol mixture) | | |
| Bio-based polyol | B2000 | 100 |
| Blow agent | H2O | 0.5-2 |
| Surfactant | B2370 | 0.5-2 |
| Pore agent | SK1900 | 0-5 |
| Nucleating agent | R974 | 0.2-2 |
| Catalyst | A300 | 0.05-1 |
| | Bismuth | 0.2-2 |
| | Neodecanoate | |
| Part B (Isocyanate mixture) | | |
| Isocyanate | TDI | 10-35 |
| Blow agent | Acetone | 0.5-5 |

In one embodiment, the bio-based polyurethane foam is produced using a single-step direct pour method. In this embodiment, a polyol-based mixture (Part A) is first prepared by combining a bio-based polyol (B2000) in an amount of 100 parts by mass, which serves as the primary renewable polyol component. A blowing agent (H2O) is added in an amount ranging from 0.5 to 2 parts by mass to facilitate foam expansion through carbon dioxide generation during reaction with isocyanate. A surfactant (B2370) is incorporated in an amount ranging from 0.5 to 2 parts by mass to stabilize the foam structure and regulate cell formation. A pore-opening agent (SK1900) is optionally added in an amount ranging from 0 to 5 parts by mass to enhance cell openness and improve foam breathability. A nucleating agent (R974) is added in an amount ranging from 0.2 to 2 parts by mass to promote uniform cell nucleation and refine foam morphology. A catalyst system comprising A300 catalyst in an amount ranging from 0.05 to 1 part by mass and bismuth neodecanoate in an amount ranging from 0.2 to 2 parts by mass is added to facilitate urethane-forming reactions and control reaction kinetics. Separately, an isocyanate-based mixture (Part B) is prepared by combining toluene diisocyanate (TDI) in an amount ranging from 10 to 35 parts by mass as the reactive isocyanate component. A physical blowing agent comprising acetone is added in an amount ranging from 0.5 to 5 parts by mass to assist foam expansion through volatilization during the exothermic reaction. Thereafter, Part A and Part B are combined and mixed to form a reactive foam-forming mixture, which is poured into a mold and allowed to foam and cure to form the bio-based polyurethane foam.

In an exemplary embodiment, Table 1B presents the formulation and component mass ratios for producing the bio-based polyurethane foam according to Embodiment 2, employing the prepolymer-based method.

TABLE 1B

| | | Mass ratio |
|---|---|---|
| Part A (prepolymer mixture) | | |
| Isocyanate (A1) | MDI | 30-50 |
| Bio-based polyol (A2) | B2000 | 20-40 |
| Flexible foam polyol (A2) | EP-330N | 2-10 |
| Part B (polyol mixture) | | |
| Bio-based polyol | B2000 | 100 |
| Blow agent | H2O | 0.5-5 |
| Surfactant | DC-193 | 0.5-3 |
| Chain Extender | BDO | 1-3 |
| Crosslinker | TMP | 1-3 |
| Catalyst | A33 | 0.2-1 |

In another embodiment, a bio-based polyurethane foam is produced using a prepolymer method to improve structural integrity and thermal resistance of the resulting foam. In this embodiment, a prepolymer mixture (Part A) is first prepared by reacting an isocyanate component comprising methylene diphenyl diisocyanate (MDI) in an amount ranging from 30 to 50 parts by mass with a bio-based polyol (Part A2) (B2000) in an amount ranging from 20 to 40 parts by mass and a flexible foam polyol (Part A2) (EP-330N) in an amount ranging from 2 to 10 parts by mass. The reaction between the isocyanate and polyol components forms an isocyanate-terminated prepolymer having controlled molecular architecture and enhanced reactivity. Separately, a secondary polyol-based mixture (Part B) is prepared by combining a bio-based polyol (B2000) in an amount of 100 parts by mass. A blowing agent (H2O) is added in an amount ranging from 0.5 to 5 parts by mass to facilitate foam expansion. A surfactant (DC-193) is added in an amount ranging from 0.5 to 3 parts by mass to stabilize the cellular structure of the foam. A chain extender comprising propanediol (BDO) is added in an amount ranging from 1 to 3 parts by mass to increase molecular weight and improve mechanical strength. A crosslinking agent comprising trimethylolpropane (TMP) is added in an amount ranging from 1 to 3 parts by mass to enhance crosslink density and improve structural stability. A catalyst (A33) is incorporated in an amount ranging from 0.2 to 1 part by mass to facilitate urethane-forming reactions. The prepolymer mixture (Part A) is subsequently combined with the secondary polyol-based mixture (Part B) and thoroughly mixed to form a reactive foam-forming composition. The mixture is then allowed to foam and cure, thereby forming the bio-based polyurethane foam. The prepolymer method enables improved control over polymer network formation, resulting in enhanced mechanical properties and improved retention of structural integrity following thermal exposure.

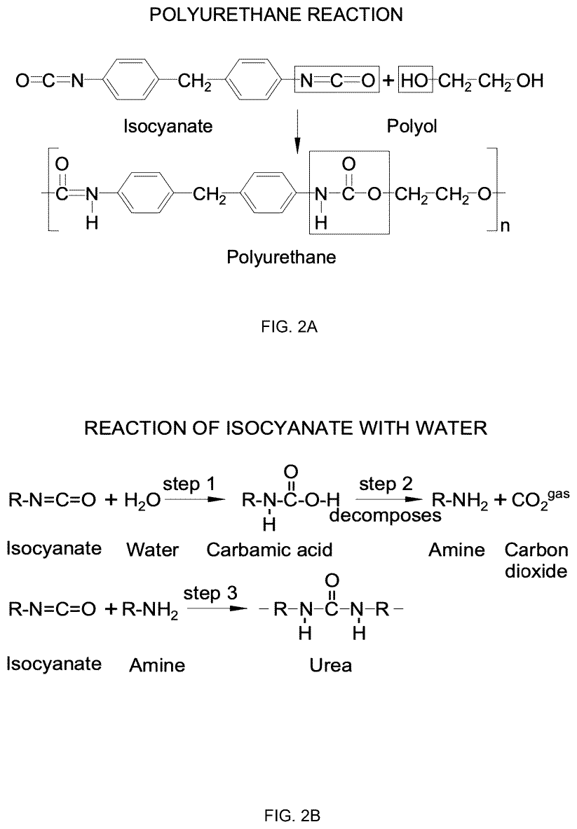

FIG. 2A illustrates a polyurethane gelling reaction between polyols and isocyanates, in accordance with an embodiment of the present invention.

FIG. 2A is illustrating the fundamental chemical reaction responsible for formation of a polyurethane polymer network during production of a bio-based polyurethane foam. The figure is showing an isocyanate compound containing reactive isocyanate groups reacting with a polyol containing hydroxyl functional groups. During this reaction, the isocyanate groups are being combined with the hydroxyl groups of the polyols, resulting in formation of urethane linkages within the polymer backbone. The reaction is being characterized by formation of repeating urethane units, which are collectively defining a polyurethane chain structure. The polymerization process is being driven by the chemical affinity between the isocyanate groups and the hydroxyl groups, leading to growth of polymer chains and development of a three-dimensional polymer network. This gelling reaction is being responsible for solidification of the reacting mixture and development of mechanical integrity of the foam. As polymerization proceeds, molecular weight of the polymer network is being increased, resulting in transition from a liquid reactive mixture to a solid polymer matrix. The reaction illustrated in FIG. 2A is being central to formation of the polyurethane framework that encapsulates additives, bio-fillers, and blowing agents within the foam structure. This gelling mechanism is being fundamental to achieving structural stability, elasticity, and load-bearing capability of the bio-based polyurethane foam produced according to the present invention.

FIG. 2B illustrates a blowing reaction involving isocyanates and water leading to gas generation, in accordance with an embodiment of the present invention.

FIG. 2B is illustrating the chemical blowing reaction occurring when isocyanate groups react with water during formation of a polyurethane foam. The figure is depicting a multi-step reaction sequence in which the isocyanate initially reacts with water to form an unstable carbamic acid intermediate. The carbamic acid is then decomposing to generate an amine and carbon dioxide gas. The carbon dioxide gas generated during this reaction is being released within the reacting mixture and is being responsible for formation of gas bubbles that expand the polymer matrix. The amine formed during deformulation is further reacting with additional isocyanate groups to form urea linkages within the polymer structure. This sequence of reactions is being simultaneously contributing to foam expansion and polymer network formation. The blowing reaction illustrated in FIG. 2B is being essential for generating the cellular structure of the foam by creating internal gas pressure that expands the reacting material. The formation of urea linkages is also being contributing to stiffness and strength of the polymer network. The controlled interaction between the gelling reaction and the blowing reaction is being responsible for development of an open-cell or controlled-cell polyurethane foam structure. This reaction mechanism is being integral to achieving uniform cell formation and desired foam density in the bio-based polyurethane foam produced according to the present invention.

The best mode of operation of the method 100 for producing the bio-based polyurethane foam is being carried out by forming a polyol-based mixture by combining one or more bio-based polyols derived from renewable resources in an amount ranging from 50 wt % to 90 wt %, together with one or more additives, and further incorporating a catalyst system comprising a gelling catalyst and or a blowing catalyst. The bio-based polyols are being selected from polyester polyols, polyether polyols, or combinations thereof, and are being characterized by a functionality ranging from 2 to 6, a hydroxyl number ranging from 20 mg potassium hydroxide per gram to 100 mg potassium hydroxide per gram, and a molecular weight ranging from 400 daltons to 12,000 daltons. The one or more additives are being incorporated in predefined amounts to regulate foam morphology, polymer network development, and processing behavior, while a bio-filler comprising cellulose nanocrystals having an average particle size ranging from 5 nanometers to 50 nanometers, and inorganic nanoparticles selected from nano-silica and nano-clay, is being optionally included to enhance nucleation and mechanical reinforcement. The catalyst system is being added in controlled amounts, with gelling catalysts present in an amount of up to 2 wt % and blowing catalysts present in an amount of up to 0.4 wt %, wherein the catalyst system is substantially free from tin-based catalysts. The polyol-based mixture is being subjected to controlled high-shear mixing in a mixing head or high-shear mixing head at a rotational speed ranging from 1,000 revolutions per minute to 10,000 revolutions per minute for a duration ranging from 1 minute to 10 minutes to obtain a homogeneous dispersion. Optionally, the homogeneous polyol-based mixture is being subjected to vacuum treatment to remove entrapped air and dissolved gases.

One or more chemical blowing agents comprising water in an amount of up to 5 wt % are being incorporated into the polyol-based mixture to enable gas generation during subsequent foaming reactions. The method 100 further comprises in the first embodiment the steps of forming an isocyanate-based mixture (Part B) by combining (i) 40-70% by weight of one or more isocyanates, and (ii) optionally a physical blowing agent; combining the obtained polyol-based mixture (Part A) and the isocyanate-based mixture (Part B) to initiate a foaming reaction; and allowing the reaction mixture to foam and cure in a mold to form the bio-based polyurethane foam. An isocyanate-based mixture is being formed by combining one or more isocyanates in an amount ranging from 40 wt % to 70 wt %, the one or more isocyanates having an isocyanate content ranging from 15% to 60%, with one or more physical blowing agents comprising acetone in an amount of up to 20 wt %. The polyol-based mixture (Part A) and the isocyanate-based mixture (Part B) are then being combined in a mixing head to initiate gelling reactions and blowing reactions, thereby forming the bio-based polyurethane foam. The method 100 further comprises in another embodiment the steps of adding a flexible foam polyol in the bio-based polyol to form Part A2; dehydrating polyol-based chemicals in Part A2; combining the polyols in Part A2 with an isocyanate (Part A1) to initiate a reaction forming a prepolymer solution (Part A); forming a secondary polyol-based mixture (Part B); combining Part A and Part B to initiate a foaming reaction; and allowing the reaction mixture to foam and cure in a mold to form the bio-based polyurethane foam. A secondary polyol-based mixture (Part B) is separately prepared, following which the prepolymer solution (Part A) is combined with Part B to initiate foaming and curing reactions. The reactive foam-forming mixture is being transferred into a mold maintained at a temperature ranging from 40° C. to 90° C. and is being allowed to expand, foam, and cure for a duration ranging from 5 minutes to 60 minutes. Following curing, the foam is being demolded and optionally subjected to post-curing at a temperature ranging from 10° C. to 40° C. for a duration ranging from 12 hours to 60 hours, thereby producing the bio-based polyurethane foam exhibiting an open-pore structure, a bio-based carbon content exceeding 80%, and enhanced mechanical properties with improved thermal stability and resistance to thermal degradation.

In various alternative embodiments, the formulations and methods described herein may be modified without departing from the scope of the present invention. Such modifications may include variations in process sequence, order of addition of components, mixing conditions, degassing or vacuum treatment steps, curing and post-curing conditions, batch or continuous processing configurations, and scale of operation. Further embodiments may include alternative bio-based polyol sources, polyol blends, isocyanate types, additive systems, bio-fillers, blowing agent systems, foam morphologies, performance characteristics, end-use applications, and equipment configurations. These embodiments are provided to illustrate the breadth of the invention and to enable future adaptation, optimization, amendment, or continuation of the disclosed subject matter.

The present invention introduces a technically advanced bio-based polyurethane foam system that achieves a high overall bio-based carbon content exceeding 80 percent while simultaneously maintaining superior mechanical performance and controlled foam morphology. The formulation integrates a high proportion of bio-based polyols together with a controlled amount of isocyanate and an optional bio-filler such as, nanosized nucleating agents, thereby establishing a balanced polymer network that supports both sustainability and structural integrity, and thermal stability. This coordinated formulation directly addresses the long-standing challenge of performance degradation typically associated with high bio-based content polyurethane foams.

A key technical advancement resides in the mandatory incorporation of nanosized nucleating agents in an amount ranging from 1 wt % to 5 wt %, having a nanoscale particle size. The nanosized nucleating agents are functioning as bio-based reinforcing fillers and nucleation centers, enabling uniform cell formation, reduced average pore size, and enhanced load-bearing capability. This nanoscale reinforcement mechanism contributes to improved compressive strength, tensile strength, and elongation at break without compromising foam flexibility, thereby enabling high mechanical performance in a predominantly bio-based system. The prepolymer solution step enables controlled reaction between hydroxyl and isocyanate groups, resulting in the formation of an isocyanate-terminated intermediate that improves crosslink density, structural uniformity, and thermal stability of the resulting bio-based polyurethane foam.

Another significant advancement is the defined use of combined chemical and physical blowing agents, or combinations thereof, wherein water and acetone are used in controlled proportions. This dual blowing strategy enables synchronized gas generation and volatilization, resulting in a stable open-cell foam structure with controlled cell size and high cell uniformity. The coordinated blowing behavior directly supports fine pore morphology and consistent foam expansion, overcoming instability commonly encountered in bio-based foam systems.

The invention further advances processing technology through mandatory high-shear mixing at rotational speeds equal to or greater than 4,000 revolutions per minute. This processing condition ensures uniform dispersion of the nanosized nucleating agents, additives, and catalysts within the polyol phase, preventing agglomeration and phase separation. The resulting homogeneous reactive mixture enables predictable gelling and blowing reactions, directly translating into consistent foam quality and reproducible material properties.

Environmental and processing safety are further advanced by the use of environmentally friendly catalyst systems that exclude tin-based catalysts. The catalyst selection enables controlled reaction kinetics while reducing toxicity and environmental impact, thereby aligning performance objectives with sustainability requirements.

Collectively, the present invention delivers a technically robust polyurethane foam system that integrates high bio-based content, nanoscale reinforcement, controlled foaming chemistry, and advanced processing conditions. These combined advancements result in a bio-based polyurethane foam exhibiting high mechanical strength, fine and uniform cell structure, superior thermal resistance, overcoming weaknesses in bio-based systems, stable open-cell morphology, and reproducible performance, thereby providing a comprehensive technical solution to challenges associated with sustainable polyurethane foam production.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

1. A bio-based polyurethane foam formulation, comprising:
a polyol component comprising 50-90% by weight of one or more bio-based polyols derived from renewable resources;
an isocyanate component comprising 40-70% by weight of one or more isocyanates;
one or more additives, optionally present, selected from nucleating agents, surfactants, pore-opening stabilizers, chain extenders, crosslinking agents, and bio-fillers;
a catalyst system comprising a gelling catalyst and/or a blowing catalyst; and
a blowing agent system comprising a chemical blowing agent and/or a physical blowing agent;
wherein all weight percentages are based on the total formulation,
wherein the bio-based polyurethane foam has a predetermined thermal decomposition temperature, a predetermined tensile strength, and a predetermined elongation at break.

2. The bio-based polyurethane foam formulation of claim 1, wherein the bio-based polyols are selected from polyester polyols, polyether polyols, or combinations thereof.

3. The bio-based polyurethane foam formulation of claim 1, wherein the bio-based polyol has a functionality of 2 to 6.

4. The bio-based polyurethane foam formulation of claim 1, wherein the bio-based polyol has a hydroxyl number of 20-100 mg KOH/g.

5. The bio-based polyurethane foam formulation of claim 1, wherein the bio-based polyol has a molecular weight of 400 to 12,000 Da and a viscosity of 20 to 2,000 cps.

6. The bio-based polyurethane foam formulation of claim 1, wherein the isocyanate component has an NCO content of 15-60% and a viscosity of 20 to 2,000 cps.

7. The bio-based polyurethane foam formulation of claim 1, wherein the one or more additives comprise nanosized nucleating agents as a bio-filler.

8. The bio-based polyurethane foam formulation of claim 7, wherein the nanosized nucleating agents are present in an amount of up to 3 wt % and have an average particle size of 5-50 nm.

9. The bio-based polyurethane foam formulation of claim 1, wherein the catalyst system comprises a gelling catalyst in an amount of up to 2 wt % and/or a blowing catalyst in an amount of up to 0.4 wt %.

10. The bio-based polyurethane foam formulation of claim 1, wherein the chemical blowing agent comprises water in an amount of up to 5 wt %.

11. The bio-based polyurethane foam formulation of claim 1, wherein the physical blowing agents are incorporated in an amount of up to 20 wt %.

12. The bio-based polyurethane foam formulation of claim 1, wherein the one or more additives comprise one or more nucleating agents present in an amount of up to 2 wt %.

13. The bio-based polyurethane foam formulation of claim 1, wherein the one or more additives comprise one or more surfactants present in an amount of up to 2 wt %.

14. The bio-based polyurethane foam formulation of claim 1, wherein the one or more additives comprise one or more pore-opening stabilizers present in an amount of up to 5 wt %.

15. The bio-based polyurethane foam formulation of claim 1, wherein the one or more additives comprise one or more chain extenders present in an amount of up to 10 wt %.

16. The bio-based polyurethane foam formulation of claim 1, wherein the one or more additives comprise one or more cross-linking agents present in an amount of up to 10 wt %.

17. The bio-based polyurethane foam formulation of claim 1, wherein the bio-based polyurethane foam exhibits:
(a) a compressive strength of at least 25 kPa,
(b) a density of less than 150 kg/m³, and
(c) an open-pore structure of at least 80%.

18. The bio-based polyurethane foam formulation of claim 1, wherein the bio-based polyurethane foam has a predetermined thermal decomposition temperature of at least 260° C., a predetermined tensile strength of at least 1,000 kPa, and a predetermined elongation at break of at least 450%.

19. The bio-based polyurethane foam formulation of claim 1, wherein the foam has a bio-based content greater than 80%.

20. A method for producing a bio-based polyurethane foam, comprising the steps of:
forming a polyol-based mixture by combining
(i) 50-90% by weight of one or more bio-based polyols derived from renewable resources,
(ii) optionally one or more additives,
(iii) a catalyst system comprising a gelling catalyst and/or a blowing catalyst, and
(iv) optionally a chemical blowing agent,
wherein all weight percentages are based on the total formulation.

21. The method of claim 20, wherein the method further comprising the steps of forming an isocyanate-based mixture (Part B) by combining (i) 40-70% by weight of one or more isocyanates, and (ii) optionally a physical blowing agent; combining the polyol-based mixture (Part A) and the isocyanate-based mixture (Part B) to initiate a foaming reaction; and allowing the reaction mixture to foam and cure in a mold to form the bio-based polyurethane foam.

22. The method of claim 20, wherein the method further comprising the steps of adding a flexible foam polyol in the bio-based polyol to form Part A2; dehydrating polyol-based chemicals in Part A2; combining the polyols in Part A2 with an isocyanate (Part A1) to initiate a reaction forming a prepolymer solution (Part A); forming a secondary polyol-based mixture (Part B); combining Part A and Part B to initiate a foaming reaction; and allowing the reaction mixture to foam and cure in a mold to form the bio-based polyurethane foam.

23. The method of claim 20, wherein the bio-based polyols are selected from polyester polyols, polyether polyols, or combinations thereof.

24. The method of claim 20, wherein forming the polyol-based mixture comprises mixing in a mixing head or high-shear mixing head at a speed of 1,000-10,000 rpm for 1-10 minutes.

25. The method of claim 20, wherein the mold temperature is maintained at 40-90° C. for 5-60 minutes.

26. The method of claim 20, further comprising demolding the foam and subjecting the foam to post-curing.
